(19) United States
(12) Patent Application Publication
(10) Pub. No.: US 2006/0251494 A1
(43) Pub. Date: Nov. 9, 2006

(54) Decorative staple

(76) Inventor: Chung-Heng Lee, Taipei Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/122,736

(22) Filed: May 5, 2005

(51) Int. Cl. F16B 15/02

(52) U.S. Cl. 411/473

(57) ABSTRACT

A decorative staple has a transverse sheet, two longitudinal sheets and patterns. The transverse sheet has a top surface, two ends and two side edges. Each longitudinal sheet is formed on a respective end of the transverse sheet and has two feet. Each foot extends perpendicularly from the side edge of the transverse sheet and has an outside edge and an inside edge. The outside edge is perpendicular to the side edge. The side edge and the outside edge provide long contact areas for multiple decorative staples to connect to one another. The feet are sharp enough for the decorative staples to penetrate the papers or the cardboard boxes.

### BACKGROUND OF THE INVENTION

1. Field of the Invention

The present invention relates to a staple, especially to a decorative staple.

2. Description of the Prior Arts

Staples are used with staplers to join papers, construct cardboard boxes, etc. The conventional staples are dull and will impair the overall attractiveness of papers or cardboard boxes. Therefore decorative staples are developed not only to function as a joining element but also to decorate the appropriate materials. With reference to FIG. 3, a conventional decorative staple (20) comprises a transverse sheet (21), two feet (22) and patterns (23). The transverse sheet (21) has two side edges (211) and two ends. Each foot (22) is formed on and extends perpendicularly down from a respective end of the transverse sheet (21) and has two perpendicular edges (221), a tip and two inclined edges (222). The perpendicular edges (221) are perpendicular to the side edges (211) of the top surface (21). The tip links the two inclined edges (222). The patterns (23) are formed on the top surface (21). The glue is spread on the side edge (211) and the perpendicular edges (221) to connect multiple conventional decorative staples (20).

If the perpendicular edges (221) are longer, the tip will be blunter. When the tip is blunter, the conventional decorative staples (20) are not easy to pass through the papers or cardboard boxes. If the tip is sharper, the perpendicular edges (221) are shorter. When the perpendicular edges (221) are shorter, the area to spread glue is smaller, and the conventional decorative staples (20) are detached from one another easily due to the insufficiency of glue.

To overcome the shortcomings, the present invention provides an improved decorative staple to mitigate or obviate the aforementioned problems.

### SUMMARY OF THE INVENTION

The main objective of the present invention is to provide a decorative staple that can connect to other decorative staples well and can penetrate the papers or the cardboard boxes easily. The decorative staple has a transverse sheet, two longitudinal sheets and patterns. The transverse sheet has a top surface, two ends and two side edges. Each longitudinal sheet is formed on each end of the transverse sheet and has two feet. Each foot extends perpendicularly from the side edge of the transverse sheet and has an outside edge and an inside edge. The outside edge is perpendicular to the side edge. The side edge and the outside edge provide long areas for multiple decorative staples to connect to one another. The feet are sharp enough for the decorative staples to penetrate the papers or the cardboard boxes.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a decorative staple in accordance with the present invention;

FIG. 2 is a perspective view of multiple decorative staples in FIG. 1; and

FIG. 3 is a perspective view of multiple decorative staples in accordance with the prior art.

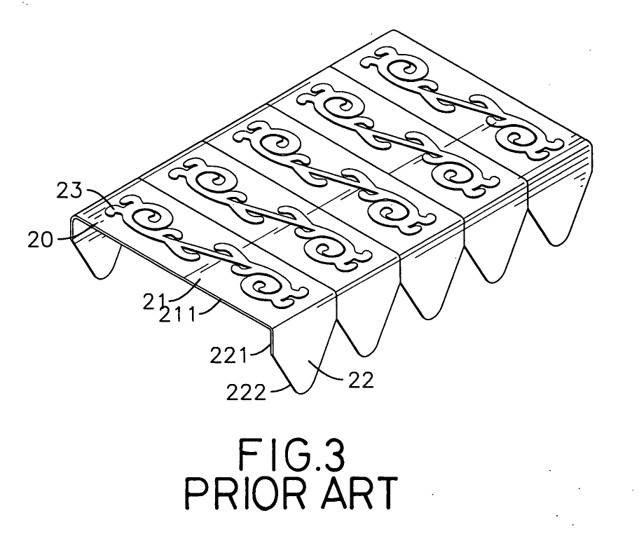

### DETAILED DESCRIPTION OF THE PREFERRED EMBODIMENTS

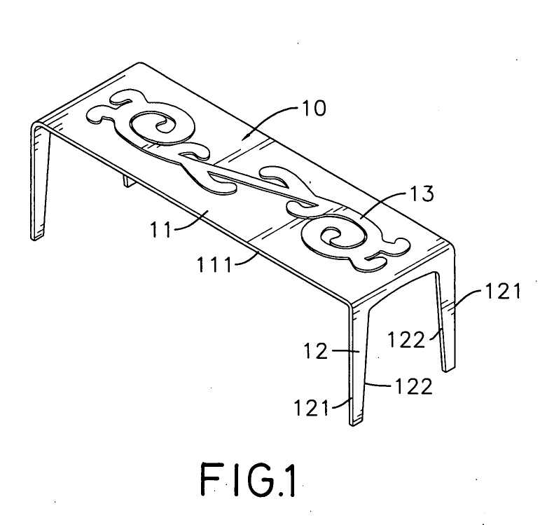

With reference to FIG. 1, a decorative staple (10) in accordance with the present invention is U-shaped and has a transverse sheet (11), two longitudinal sheets and patterns (13).

The transverse sheet (11) has a top surface, two side edges (111) and two ends.

Each longitudinal sheet is U-shaped, is formed on and extends perpendicularly from the respective end of the transverse sheet (11) and has two feet (12). Each foot (12) extends perpendicularly from each side edge (111) of the transverse sheet (11) and has an outside edge (121) and an inside edge (122). The outside edge (121) is perpendicular to the side edge (111) of the transverse sheet (11). The inside edge (122) may taper downward and toward the outside edge (121).

The patterns (13) are formed on the top surface of the transverse sheet (11).

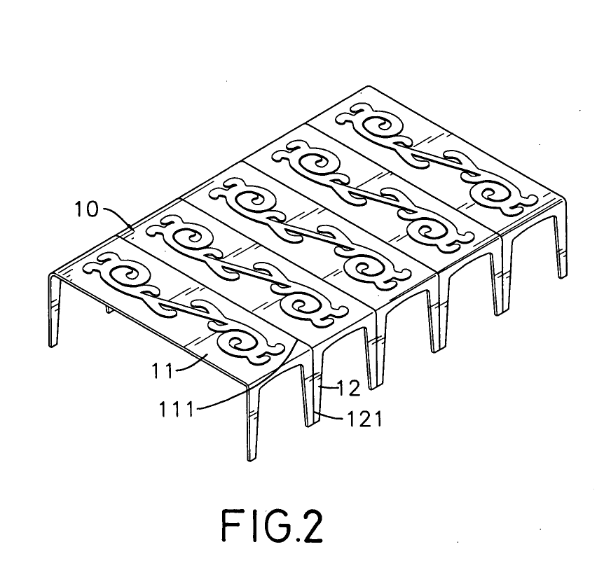

With further reference to FIG. 2, glue is spread on the side edges (111) of the transverse sheets and the outside edges (121) of the longitudinal sheets to connect multiple decorative staples (10).

The decorative staple (10) as described has numerous advantages. The side edges ( 111) and outside edges (121) provide long contact areas for multiple decorative staples (10) to connect to one another. The feet (12) are sharp enough for the decorative staples (10) to penetrate the papers or the cardboard boxes.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A decorative staple having
a transverse sheet having a top surface, two side edges and two ends, with the two side edges being straight and parallel between the two ends;
two longitudinal sheets being U-shaped, formed on and extending perpendicularly respectively from the ends of the transverse sheet and having two feet, with each foot having
an outside edge perpendicular to and contiguous with the side edge of the transverse sheet; and
an inside edge, with the outside edges of the two feet being straight and parallel and spaced equal to the two side edges of the transverse sheet, with the inside edges of the two feet spaced from each other and located intermediate the outside edges of the two feet;
glue spread on the two side edges of the transverse sheet and on the outside edges of the two feet of each of the two longitudinal sheets; and
decorative patterns formed on the top surface of the transverse sheet.

2. The decorative staple as claimed in claim 1, wherein the inside edge of each foot of each longitudinal sheet is tapered downward and toward the outside edge of the foot of the longitudinal sheet.

3. An assembly comprising:
a plurality of decorative staples, with each decorative staple having
a transverse sheet having a top surface, two side edges and two ends, with the two side edges being straight and parallel between the two ends;
two longitudinal sheets being U-shaped, formed on and extending perpendicularly respectively from the ends of the transverse sheet and having
two feet, with each foot having
an outside edge perpendicular to and contiguous with the side edge of the transverse sheet; and
an inside edge, with the outside edges of the two feet being straight and parallel and spaced equal to the two side edges of the transverse sheet, with the inside edges of the two feet spaced from each other and located intermediate the outside edges of the two feet;
decorative patterns formed on the top surface of the transverse sheet, with the plurality of decorative staples arranged with the transverse sheets located in a single plane with the side edges of adjacent decorative staples abutting and with the two longitudinal sheets each formed in a single plane with the outside edges of the adjacent decorative staples abutting; and
glue spread between the abutting side edges and the abutting outside edges of the adjacent decorative staples.

4. The assembly of claim 3, wherein the inside edge of each foot of each longitudinal sheet is tapered downward and toward the outside edge of the foot of the longitudinal sheet.
